(19) United States
(12) Patent Application Publication
(10) Pub. No.: US 2025/0144826 A1
(43) Pub. Date: May 8, 2025

(54) Knife With Quickly Adjustable Elasticity

(71) Applicant: Junjing Luo, Emeishan (CN)

(72) Inventor: Junjing Luo, Emeishan (CN)

(21) Appl. No.: 19/014,389

(22) Filed: Jan. 9, 2025

(30) Foreign Application Priority Data
Nov. 27, 2024 (CN) 202422902719.6

(51) Int. Cl. B26B 1/10; B26B 1/04

(52) U.S. Cl. CPC B26B 1/10; B26B 1/046

(57) ABSTRACT

A knife with quickly adjustable elasticity comprises a blade, a pair of pull rod springs and two handle covers arranged opposite to each other, wherein a receiving cavity for receiving the blade is reserved between the handle covers, an end, opposite to a blade tip, of the blade is connected to the handle covers by means of a spindle, assembly and disassembly holes are formed in corresponding positions of the two handle covers, one end of an adjusting element is mounted in the assembly and disassembly holes by means of an articulated shaft, and the other end of the adjusting element is locked to the handle covers by means of a fastener. When the force of the pull rod is adjusted, it is unnecessary to disassemble all components of the knife.

### TECHNICAL FIELD

The invention relates to the technical field of knives, in particular to a knife with quickly adjustable elasticity.

### DESCRIPTION OF RELATED ART

It is commonly known that although knives are dangerous in use, they can bring much convenience in daily life as long as they are properly used. Cross bar lock folding knives, a blade of which can be received in a handle, are easy to store and carry, thus being popular with related users and particularly suitable for outdoor life. The blade of the cross bar lock folding knives, which are one type of folding knives, can be automatically and quickly pushed out of the handle by means of the resilience of a spring arranged between the blade and the handle.

At present, to adjust the force (elasticity) of pull rod springs of an existing cross bar lock folding knife, spindle nail screws and screws for fixing a spacer sleeve need to be detached, and then the force of the pull rod is adjusted by adjusting receding positions of pull rod springs. However, such a structural design has the following problems:
First, when the folding knife is reassembled, it is difficult to assemble together all components of the folding knife under the action of the elastic force of the pull rod springs, leading to low assembly efficiency; second, when the folding knife is maintained and switched to a different usage mode later, the process of adjusting the force of the pull rod springs is complex, and multiple components have to be disassembled to adjust the pull rod springs; third, for a calibrated folding knife, after spindle nails are removed for adjusting the force of the pull rod springs, the position of the pull rod springs will be changed, and the position of the pull rod springs is not unique, so when the folding knife is reassembled, it is difficult to adjust the elasticity accurately, greatly reducing usage experience.

### BRIEF SUMMARY OF THE INVENTION

In view of the defects in the prior art, the purpose of the invention is to provide a knife with quickly adjustable elasticity.

To fulfill the above purpose, the invention adopts the following technical solution:
A knife with quickly adjustable elasticity comprises a blade, a pair of pull rod springs and two handle covers arranged opposite to each other, wherein a receiving cavity for receiving the blade is reserved between the handle covers, an end, opposite to a blade tip, of the blade is connected to the handle covers by means of a spindle, assembly and disassembly holes are formed in corresponding positions of the two handle covers, one end of an adjusting element is mounted in the assembly and disassembly holes by means of an articulated shaft, the other end of the adjusting element is locked to the handle covers by means of a fastener, a sliding slot is formed in the adjusting element, a pull rod is mounted in the sliding slot and is able to slide back and forth along the sliding slot, one end of each pull rod spring is provided with a barbed portion, the other end of each pull rod spring is bent to form an insertion end, insertion holes are formed in the adjusting element, at least two insertion positions are arranged in each insertion hole, sockets are formed in two ends of the pull rod, the barbed portions of the pull rod springs are hooked in the sockets, and the insertion end of each pull rod spring is selectively inserted into one insertion position;
an arc tip is arranged at the end, where the spindle is arranged, of the blade, a first clamping groove is formed in one side of the arc tip, a second clamping groove is formed in the other side of the arc tip, a receding space is formed in a lower end of the adjusting element, the arc tip is arranged in the receding space, and under the action of the pull rod springs, a rod body of the pull rod keeps abutting against an end surface of the arc tip.

Preferably, receding holes are formed in positions, corresponding to the sliding slot, of the handle covers to uncover top surfaces of the two ends of the pull rod.

Preferably, a bump that protrudes outwardly is arranged at a position, corresponding to the receding holes, of the adjusting element.

Preferably, the fastener is a screw.

Preferably, a push button used by users to push the blade to rotate is arranged at a position close to a back of the blade, and the push button is uncovered.

Preferably, a top of the push button is mushroom-shaped and provided with a first anti-slip surface.

Preferably, second anti-slip surfaces are arranged on a back of the blade and side surfaces of the handle covers.

Preferably, a clip is arranged on one said handle cover.

By adopting the above technical solution, when the force of the pull rod is adjusted, it is unnecessary to disassemble all components of the knife, only the fastener for locking the adjusting element needs to be disassembled to rotate out the adjusting element so as to uncover the pull rod springs, and then, the elasticity can be adjusted by inserting the insertion ends into different insertion positions; in addition, by designing multiple fixed insertion positions, the elasticity of the knife can be adjusted based on the fixed positions, and users can select desired elasticity according to the positions; moreover, the pull rod springs, as the most vulnerable parts, are assembled by hooking the barbed portions in the sockets, such that the pull rod springs can be replaced easily and conveniently, thus facilitating maintenance.

### BRIEF DESCRIPTION OF THE SEVERAL VIEWS OF THE DRAWINGS

FIG. 1 is a schematic structural view according to one embodiment of the invention.

FIG. 2 is an exploded structural view according to one embodiment of the invention.

FIG. 3 is a schematic structural view of an adjusting element according to the invention.

FIG. 4 is a sectional structural view in a case where a blade is unfolded according to one embodiment of the invention.

FIG. 5 is a sectional structural view in a case where a blade is folded according to one embodiment of the invention.

### DETAILED DESCRIPTION OF THE INVENTION

To better clarify the purposes, technical solutions and advantages of the invention, the invention is described in further detail below in conjunction with accompanying drawings and embodiments. It should be understood that the specific embodiments described here are merely used for explaining the invention rather than limiting the invention.

In the description of the invention, it should be understood that terms “central”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise” and “anticlockwise” are used to indicate directional or positional relations based on the accompanying drawings merely for the purpose of facilitating and simplifying the description of the invention rather than indicating or implying that devices or elements referred to must be in a specific direction or be configured and operated in a specific direction, and thus should not be construed as limitations of the invention. In addition, terms “first” and “second” are merely used for the purpose of description and should not be construed as indicating or implying relative importance or implicitly indicating the number of technical features referred to. Therefore, a feature defined by “first” or “second” may explicitly or implicitly indicate the inclusion of one or more said feature. In the description of the invention, “multiple” refers to two or more, unless otherwise expressly defined.

In the description of the invention, it should be noted that, unless otherwise expressly stated and defined, terms “mount”, “link” and “connect” should be broadly understood. For example, “connect” may refer to fixed connection, detachable connection or integrated connection; or, mechanical connection or electrical connection; or, direct connection, indirect connection by means of an intermediate medium, internal connection or interaction of two elements. Those ordinarily skilled in the art can appreciate the specific meanings of these terms in the invention as the case may be.

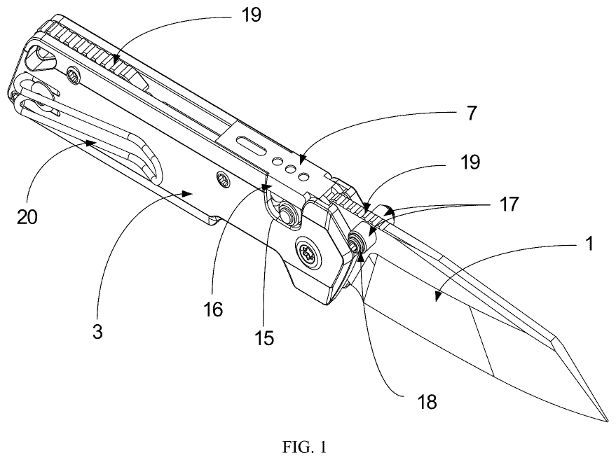

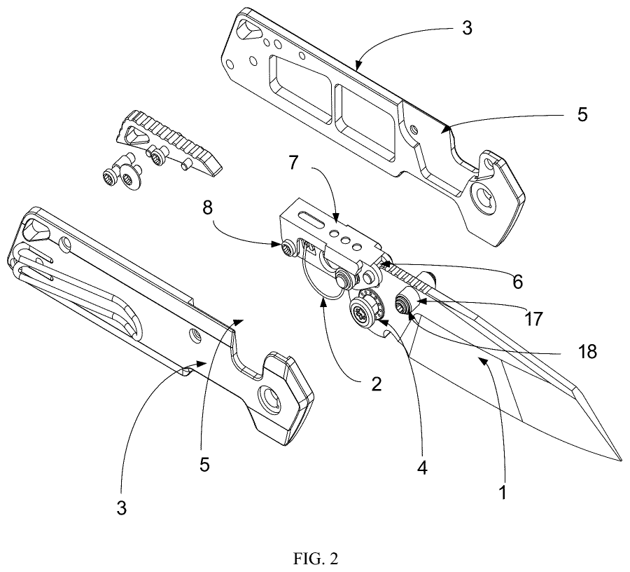

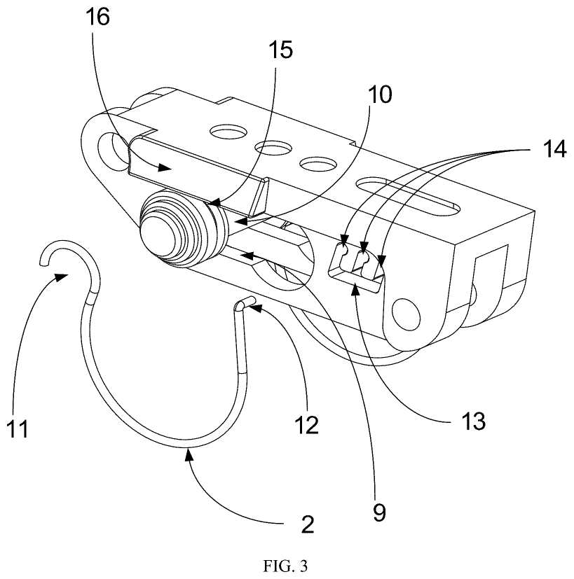

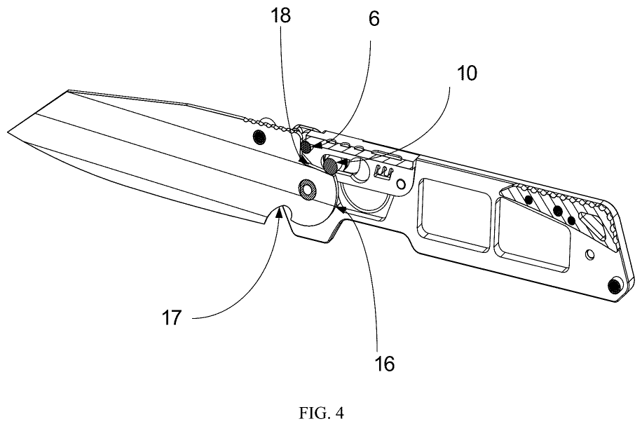

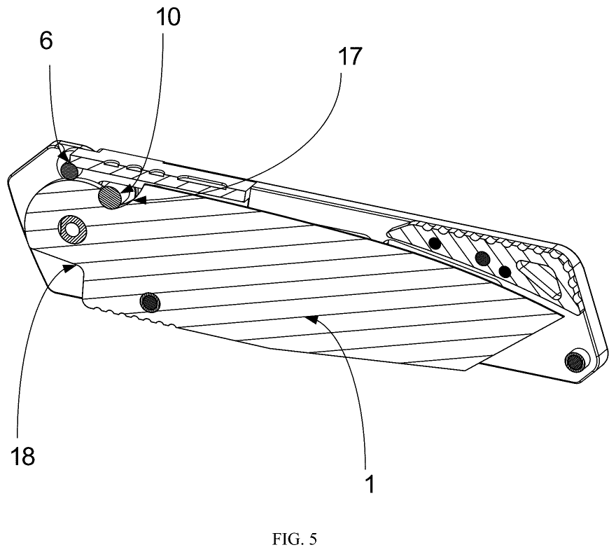

As shown in FIGS. 1-5, this embodiment provides a knife with quickly adjustable elasticity, comprising a blade 1, a pair of pull rod springs 2 and two handle covers 3 arranged opposite to each other, wherein a receiving cavity for receiving the blade 1 is reserved between the handle covers 3, an end, opposite to a blade tip, of the blade 1 is connected to the handle covers 3 by means of a spindle 4, assembly and disassembly holes 7 are formed in corresponding positions of the two handle covers 3, one end of an adjusting element 7 is mounted in the assembly and disassembly holes 5 by means of an articulated shaft 6, the other end of the adjusting element 7 is locked to the handle covers 3 by means of a fastener 8, the fastener 8 is a screw, a sliding slot 9 is formed in the adjusting element 7, a pull rod 10 is mounted in the sliding slot 9 and is able to slide back and forth along the sliding slot 9, a barbed portion 11 is arranged at one end of each pull rod spring 2, the other end of each pull rod spring 2 is bent to form an insertion end 12, insertion holes 13 are formed in the adjusting element 7, at least two insertion positions 14 are arranged in each insertion hole 13, sockets 15 are formed in two ends of the pull rod 10, the barbed portions 11 of the pull rod springs 2 are hooked in the sockets 15, and the insertion end 12 of each pull rod spring 2 is selectively inserted into one insertion position 12;
an arc tip 16 is arranged at the end, where the spindle 4 is arranged, of the blade 1, a first clamping groove 17 is formed in one side of the arc tip 16, a second clamping groove 18 is formed in the other side of the arc tip 16, a receding space is formed in a lower end of the adjusting element 7, the arc tip 16 is arranged in the receding space, and under the action of the pull rod springs 2, a rod body of the pull rod 10 keeps abutting against an end surface of the arc tip 16.

In specific use of the knife, the blade 1 is in a folded state by default, and the pull rod 10 is located in the first clamping groove 17. When the blade 1 needs to be pushed out, the blade 1 is pushed to rotate outwards; in the rotation process of the blade 1, the arc tip 16 of the blade 1 keeps abutting against the pull rod 10 to drive the pull rod 10 to move in the sliding slot 9, and at this moment, the pull rod springs 3 will deform; when the pull rod 10 is pushed back to the other end of the sliding slot 9, the vertex of the longest edge of the arc tip 16 exactly abuts against the pull rod 10, the blade 1 is further rotated until the longest edge of the arc tip 16 is separated from the pull rod 10, at this moment, the pull rod 10 will be pushed into the second clamping groove 18 under the action of a reactive force of the deformed pull rod springs 3, and the blade 1 is limited by the pull rod 10 and pressed by the articulated shaft 6 corresponding to the adjusting element 7, thus being prevented from further rotation. When the blade 1 needs to be folded, the blade 1 is pushed to rotate backwards, then the pull rod 10 is pushed to retreat, and the pull rod springs 3 deform again until the pull rod 10 returns into the first clamping groove 17, such that the blade 1 is folded.

When the elasticity of the knife needs to be adjusted, it is unnecessary to disassemble all components of the knife, only the fastener 8 for locking the adjusting element 7 needs to be detached to unlock the corresponding end of the adjusting element 7, then the adjusting element 7 can be rotated out to directly uncover the pull rod springs 2, and then the insertion ends 12 of the pull rod springs 2 can be inserted into different insertion positions 14. The longer the distance between the insertion ends 12 of the pull rod springs 2 and the insertion positions 14 where the insertion ends 12 are inserted, the larger the elasticity; the shorter the distance between the insertion ends 12 of the pull rod springs 2 and the insertion positions 14 where the insertion ends 12 are inserted, the smaller the elasticity. After the elasticity of the knife is adjusted, the adjusting element 7 is rotated back and locked 7. In this way, the elasticity of the knife can be easily adjusted; in addition, by designing multiple fixed insertion positions 14, the elasticity of the knife can be adjusted based on the fixed positions, and users can select desired elasticity according to the positions; moreover, the pull rod springs 2, as the most vulnerable parts, are assembled by hooking the barbed portions 11 in the sockets 15, such that the pull rod springs 2 can be replaced easily and conveniently, thus facilitating maintenance.

Further, to allow users to push back the pull rod springs 2 manually when necessary, in this embodiment, receding holes 15 are formed in positions, corresponding to the sliding slot 9, of the handle covers 3 to uncover top surfaces of the two ends of the pull rod 10. In this way, the pull rod 10 can be pushed back manually.

Further, to allow users to rotate out the adjusting element 7 after the adjusting element 7 is unlocked by the fastener 8, in this embodiment, a bump 16 that protrudes outwardly is arranged at a position, corresponding to the receding holes 15, of the adjusting element 7. In this way, users can apply a force by means of the bump 16 to rotate the adjusting element 7.

Further, to allow users to manually push the blade 1 to rotate, in this embodiment, a push button 17 used by users to push the blade 1 to rotate is arranged at a position close to a back of the blade 1, and the push button 17 is uncovered. In this way, when the blade 1 needs to be pushed out, users can push the blade 1 to rotate outwards with their thumb by means of the push button 17.

Further, to fulfill an anti-slip effect, in this embodiment, the top of the push button 17 is mushroom-shaped and provided with a first anti-slip surface 21, and the first anti-slip surface 21 may be a helical surface or step surface.

Further, to prevent the knife from slipping out of user's hands in use, in this embodiment, second anti-slip surfaces 19 are arranged on the back of the blade 1 and side surfaces of the handle covers 3, and the second anti-slip surfaces 19 may be saw-toothed strips.

In addition, to ensure that the knife can be carried easily, in this embodiment, a clip 20 is arranged on one handle cover 3, and the knife can be clipped on a backpack, a pocket, a belt or other articles by means of the clip 20.

The above embodiments are merely preferred ones of the invention and are not intended to limit the patent scope of the invention. All equivalent structure or flow transformations made based on the above description and accompanying drawings, or direct or indirect applications to other related technical fields should also fall within the patent protection scope of the invention.

What is claimed is:

1. A knife with quickly adjustable elasticity, comprising a blade, a pair of pull rod springs and two handle covers arranged opposite to each other, wherein a receiving cavity for receiving the blade is reserved between the handle covers, an end, opposite to a blade tip, of the blade is connected to the handle covers by means of a spindle, assembly and disassembly holes are formed in corresponding positions of the two handle covers, one end of an adjusting element is mounted in the assembly and disassembly holes by means of an articulated shaft, the other end of the adjusting element is locked to the handle covers by means of a fastener, a sliding slot is formed in the adjusting element, a pull rod is mounted in the sliding slot and is able to slide back and forth along the sliding slot, one end of each said pull rod spring is provided with a barbed portion, the other end of each said pull rod spring is bent to form an insertion end, insertion holes are formed in the adjusting element, at least two insertion positions are arranged in each said insertion hole, sockets are formed in two ends of the pull rod, the barbed portions of the pull rod springs are hooked in the sockets, and the insertion end of each said pull rod spring is selectively inserted into one said insertion position;
an arc tip is arranged at the end, where the spindle is arranged, of the blade, a first clamping groove is formed in one side of the arc tip, a second clamping groove is formed in the other side of the arc tip, a receding space is formed in a lower end of the adjusting element, the arc tip is arranged in the receding space, and under the action of the pull rod springs, a rod body of the pull rod keeps abutting against an end surface of the arc tip.

2. The knife with quickly adjustable elasticity according to claim 1, wherein receding holes are formed in positions, corresponding to the sliding slot, of the handle covers to uncover top surfaces of the two ends of the pull rod.

3. The knife with quickly adjustable elasticity according to claim 2, wherein a bump that protrudes outwardly is arranged at a position, corresponding to the receding holes, of the adjusting element.

4. The knife with quickly adjustable elasticity according to claim 3, wherein the fastener is a screw.

5. The knife with quickly adjustable elasticity according to claim 1, wherein a push button used by users to push the blade to rotate is arranged at a position close to a back of the blade, and the push button is uncovered.

6. The knife with quickly adjustable elasticity according to claim 5, wherein a top of the push button is mushroom-shaped and provided with a first anti-slip surface.

7. The knife with quickly adjustable elasticity according to claim 1, wherein second anti-slip surfaces are arranged on a back of the blade and side surfaces of the handle covers.

8. The knife with quickly adjustable elasticity according to claim 7, wherein a clip is arranged on one said handle cover.
